(19) United States
(12) Patent Application Publication
(10) Pub. No.: US 2012/0033919 A1
(43) Pub. Date: Feb. 9, 2012

(54) TRANSITION FOR AN OPTICAL FIBER RIBBON

(75) Inventors: Jeremy CALAC, LE MANS (FR); Guillaume PEIGNE, LE MANS (FR)

(73) Assignee: CARRIER KHEOPS BAC, ALLONNES (FR)

(21) Appl. No.: 13/204,222

(22) Filed: Aug. 5, 2011

(30) Foreign Application Priority Data
Aug. 6, 2010 (FR) 10 56484

(51) Int. Cl. G02B 6/36; B23P 11/00

(52) U.S. Cl. 385/76; 29/428

(57) ABSTRACT

A transition for a submarine optical connector, defining a through-hole (11) for an optical fiber ribbon surrounded by a plastic sheath, and comprising, in said through-hole:
at least one stripped portion (33) of the optical fiber ribbon; and
some epoxy adhesive (17) coating at least the stripped portion of the ribbon and at least partly filling the through-hole so as to fasten the optical fiber ribbon to the transition.

The invention relates to the production of a transition (or pressure crossing) for an optical fiber ribbon for a submarine optical connector.

It is known to be very difficult to seal a transition for an optical fiber ribbon cable at the rear part of an optical connector that can withstand the high pressures in a submarine environment, i.e. at pressures of above 300 bar.

The optical fiber ribbon is coated with a protective sheath which is not watertight at these high pressures.

Moreover, no transition or watertight barrier that can withstand the high pressures in a submarine environment, suitable for optical fiber ribbon connectors is known.

There is therefore a need for a watertight transition able to withstand high pressures for an optical fiber ribbon cable.

The invention provides a method of producing a transition for an optical fiber ribbon for a submarine optical cable, the method comprising the following steps:
a cable comprising an optical fiber ribbon surrounded by a plastic sheath is provided;
a through-hole, for the ribbon to pass through a support piece, and a hole transverse to the through-hole, capable of allowing an adhesive in the form of a liquid or viscous fluid to flow into the through-hole, are provided;
the ribbon is mechanically stripped (at the end or in its middle) over a portion of its length corresponding to that of its passage in the support piece, this length being slightly smaller than that of the through-hole;
the remaining, not mechanically stripped, portion of the ribbon is chemically stripped by means of a solvent for the plastic of the ribbon;
the ribbon is passed into the through-hole of the support piece, placing the stripped portion within the through-hole;
an adhesive of the epoxy type, in liquid or even viscous form, is injected into the transverse hole until the adhesive coats at least the stripped portion of the ribbon and at least partly fills the through-hole; and
the transverse hole is plugged at its end.

This arrangement has the effect of creating a watertight seal for the stripped optical fibers of the ribbon cable, which sealingly and strongly adheres to the silica body of the fibers and to the walls of the through-hole for passage of the cable into the support piece, and optionally to the edges of the through-hole. Such a fiber seal can withstand pressures up to 1600 bar in a marine environment.

The dimensions of the through-hole for the ribbon in the support piece correspond in cross section, preferably to within a small clearance, i.e. to within about 1 mm, to that of the ribbon. This allows the through-hole to be at least partly filled with the adhesive.

The ribbon is passed into the through-hole of the support piece by placing the stripped portion, preferably centered or close to the through-hole of the ribbon, for example by marking one of its ends. This ensures that the adhesive adheres simultaneously to the walls of the through-hole and to the stripped portion of the ribbon.

The ribbon is held in position, in the centered position or close to the through-hole, preferably by means of a tool for holding the cable in position relative to the support piece, for example with a retaining template for holding the cable in place on the support piece (preferably by means of a HT (high temperature) adhesive tape bonded to the cable on either side of the support piece). This ensures that the ribbon is in a stable position relative to the support piece.

Injection of the epoxy adhesive into the transverse hole is preferably carried out, and for safety, until the adhesive protrudes from each side of the through-hole of the support piece.

Advantageously, the adhesive injected into the support piece is polymerised, preferably at a polymerisation temperature above the ambient temperature but below the temperature at which the optical fiber ribbon cable is impaired (for example for one hour at 80° C.). In this way, any creep of the injected adhesive is limited and the polymerisation of the adhesive is accelerated.

Advantageously, the step consisting in mechanically stripping the ribbon over a portion of its length corresponding to that of its passage in the support piece is carried out over a length slightly smaller than that of the through-hole, being set back by at least 1 mm at each end of the through-hole.

The invention also provides a device for producing a transition for an optical fiber ribbon surrounded by a plastic sheath in a support piece of a submarine optical connector, the device comprising:
means for mechanically stripping at least one optical fiber ribbon over a defined length corresponding to the passage of the ribbon in a through-hole in the support piece;
means for chemically stripping the not mechanically stripped portion of the ribbon by means of a solvent for the plastic of the ribbon; and
means for injecting an adhesive of epoxy type, in liquid or even viscous form, into the through-hole until the adhesive coats at least the stripped portion of the ribbon and at least partly fills the through-hole.

The mechanical stripping means may for example comprise:
a support plate for supporting the optical fiber ribbons that are placed parallel to one another on a grooved part of the support plate, having a calibrated cross section partly corresponding to that of the optical fiber ribbons;
means for fastening the optical fiber ribbons; and
means for cutting into the surface of the sheath of the optical fiber ribbons, these being intended to strip the ribbons over the defined length.

Thus, the optical fiber ribbons may be held trapped in the grooves of the support plate.

The cutting means may comprise a blade designed to be moved along the optical fiber ribbons, preferably in the grooved part of the support plate, parallel to the latter and over a course corresponding to the defined length, away from the means for fastening the ribbons. Thus, the cutting of the ribbons is carried out with the ribbons in tension relative to the fastening means, thereby making it easier for them to be held in place on the support plate.

The blade may be designed to have a cutting section capable of cutting the portion of the sheath placed above the silica optical fiber body, as a thin cut strip.

The fastening means may comprise a system of clamps or the like, these being intended to receive, clamped between it and the support plate, the optical fiber ribbons. This fastening system preferably includes an intermediate pad for protecting the optical fiber ribbons.

This device may comprise in succession from the upstream end to the downstream end in the direction of advance of the blade over the optical fiber ribbons, a clamping assembly, for clamping the optical fiber ribbons, the blade for stripping the ribbons, which is mounted so as to move relative to the support plate for the ribbons, and a retaining bar for holding the ribbons in place.

The invention also provides a transition for a submarine optical connector, defining a through-hole for an optical fiber ribbon surrounded by a plastic sheath, and comprising, in said through-hole:
at least one stripped portion of the optical fiber ribbon; and
adhesive of epoxy type, coating at least the stripped portion of the ribbon and at least partly filling the through-hole so as to fasten the optical fiber ribbon to the transition.

The invention also provides an optical connector having the aforementioned transition.

One embodiment of the invention will now be described with reference to the appended drawing in which:

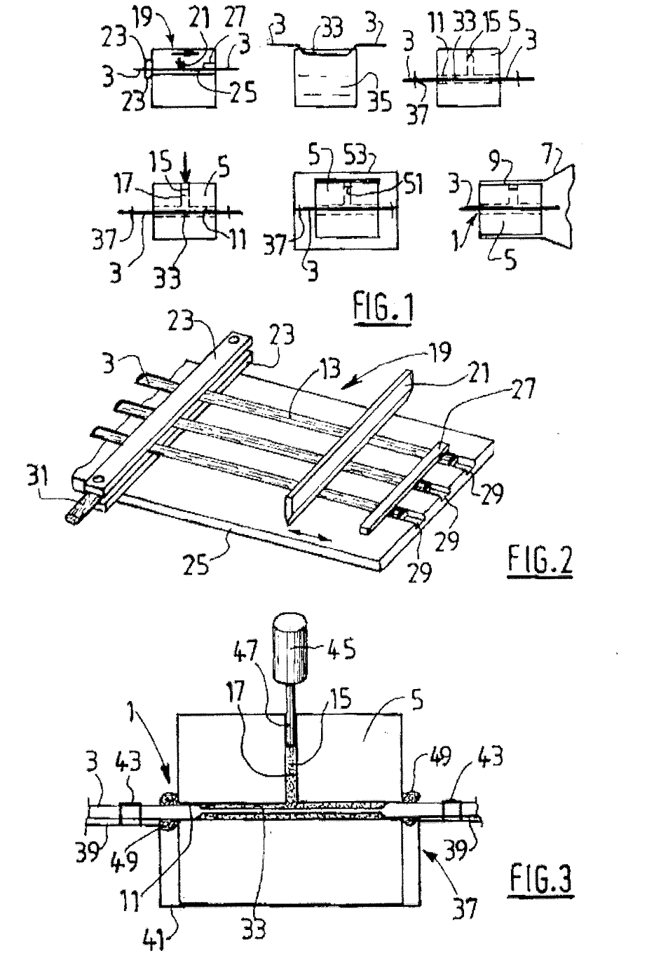

FIG. 1 is a block diagram illustrating the various steps of the method for producing a transition for an optical fiber ribbon cable in a support piece for a submarine optical connector according to one embodiment of the invention;

FIG. 2 is a partial schematic perspective view illustrating the mechanical stripping of the optical fiber ribbons of the optical cable; and

FIG. 3 is a cross-sectional diagram of the support piece showing the through-hole for an optical fiber ribbon of the optical cable and the injection of adhesive onto the stripped portion of the optical fiber ribbon.

FIG. 1 shows a method of producing a pressure-resistant watertight transition 1 for an optical fiber ribbon cable 3 in a support piece 5, this transition being designed to be firmly mounted on a submarine optical connector 7 and to connect the optical fiber 3 to the rear carcass part 9 of the optical connector 7.

The essential steps of the method have been shown schematically in the form of successive blocks.

Firstly, the support piece 5 of the optical connector 7 (not shown) is machined so that it can receive the optical cable 3, therefore providing, in this support piece, a hole 11 of oblong cross section passing through the support piece 5 and intended to receive the cable 3, and more precisely the ribbon 13 consisting of adjacent optical fibers, for example of the MT ferrule type, of the optical cable 3.

The dimensions in cross section of the hole 11 corresponds to within a small clearance, for example to within 1 mm, to the cross section of the optical fiber ribbon 13.

A second, blind hole 15 is formed, this being transversely connected to the first hole (11), approximately in the central region of the latter (cf. also FIG. 3) and emerging at the surface of the support piece 5. This second hole is, designed to allow adhesive 17 in viscous form to pass into the first hole 11, as will be explained later. The diameter of the second hole is about 1 mm.

A first step of the method consists in stripping the cable 3, more precisely the optical fiber ribbon 13, by means of a blade device 19 shown schematically and partially in FIG. 2.

This device 19 comprises, in succession from the upstream end to the downstream end in the direction of advance of the blade 21, a set of two opposed clamping bars 23, for clamping the optical fiber ribbons 13, a blade 21 for stripping the ribbons 13, which is able to move relative to a fixed support plate 25 for supporting the ribbons 13, and a retaining bar 27 for holding the ribbons 13 in place while they are being stripped by the blade 21.

One or more optical fiber ribbons 13 are thus placed on the support plate 25, the surface of the latter being grooved so as to accommodate each of these ribbons in parallel grooves 29, the width of which corresponds to that of each ribbon 13. These grooves 29 are parallel to the direction of advance (along the arrow) of the blade 21. The depth of these grooves 29 is defined so that the optical fibers of the ribbon in contact with the support plate 25 protrude from the grooves 29 by at least the thickness of the protective sheath of the fibers plus that of the ribbon, i.e. about 0.1 mm, for conventional optical fibers with a 120 μm diameter for the silica body with a ribbon thickness of 310 μm. The depth of the grooves 29 may thus be about 200 μm, the blade being moved very close to the grooved surface 29 of the support plate 25 and cutting the protruding section of the fiber ribbon (with a thickness of about 310 μm) at the surface of the plate 25.

The ribbons 13 thus positioned, each in one of the grooves 29, are held in position laterally on the support plate 25. These ribbons 13 are also held in position, clamped by means of an intermediate protective pad 31, between the clamping bars 23. This prevents them from sliding under the tensile cutting force for stripping the protective sheath via the blade 21, while the ribbons 13 are being held in position, downstream, by the retaining bar 27 placed against the ribbons 13, in contact with a small area (side clearance) against the latter.

The blade 21 is designed to have a cutting section, for example beveled, capable of cutting that portion of the sheath placed above the silica body of the optical fiber, as a thin cut strip about 100 μm in thickness.

This blade 21 is moved over the ribbons 13, along the arrow, over a length slightly smaller than that of the through-hole 11 of the support piece 5, corresponding to the desired stripping length of the optical fibers of the ribbon 13.

This length of the stripped portion 33 of the optical fibers may be from 1 to several mm smaller than that of the through-hole 11 so that, in the centered position of the stripped portion 33 in the through-hole 11, the stripped portion 33 of each of the fibers, all at the same level transversely to the ribbon, is slightly set back from the edge of the through-hole 11, by half of the aforementioned value.

According to this mechanical stripping method using an upper blade 21, a first strip of the protective sheath of the ribbons 13 is cut without removing it, each of the ribbons 13 treated is turned over and the cut strip rests on the bottom of the groove 29 so as to act as a cutting seat for stripping the portion of the ribbon sheath opposite that already cut. This new cut or second cut strip is opposite the first one (having the same start, the same end and even the same cut depth) and when this second cut has been completed, the first and second cut protective strips are removed. The ribbon 13 is then practically stripped apart from the lateral portions of the optical fibers, which is also easy to remove (by manually cutting it).

Next, the operation of chemically stripping the mechanically stripped ribbon portion 33, shown in the second block diagram at the top towards the right in FIG. 1, is carried out so as to remove all traces, in dust form, of the plastic for protecting the fibers that might remain on the stripped portion 33. The stripped portion 33 may for example be dipped into a solvent 35 for the plastic, for example a paint stripper, for a defined time corresponding to this chemical dissolution of the aforementioned impurities.

Once the chemical stripping operation has been carried out, the stripped portion 33 may be cleaned and degreased, for example using an alcohol-based solvent (not shown). This operation improves the quality of adhesion of the adhesive in the bonding operation described later.

The cable 3 or fiber ribbon 13 is then inserted into the through-hole 11, the position of the stripped portion 33 relative to the through-hole 11 is marked and this stripped portion 33 is held in position relative to the support piece 5. This situation is shown by the third block diagram, toward the right just after the chemical stripping. The centering of the portion 33 in the through-hole 11 may be accomplished by means of a marker reference on the ribbon positioned at a defined distance from the support piece on one side of the latter (not shown).

The stripped portion 33 is held in position relative to the through-hole 11 of the support piece 5 by means of a retaining template 37 (cf. also FIG. 3) comprising for example a support plate 39 for the ribbon 13 and a recessed part 41, which immobilizes the support piece 5 in such a way that the ribbon 13 can be placed in contact with the plate 39, being fastened to the latter for example by an HT (high temperature) adhesive tape 43 bonded to the ribbon 13 and to the plate 39, on either side of the support piece 5, as may be seen in FIG. 3.

Next (see the fourth successive block diagram), the epoxy adhesive 17, which may be a one-component adhesive or a two-component adhesive (with a hardener), is injected into the transverse hole 15 at the through-hole 11. This adhesive 17 is for example injected by a syringe 45 the needle 47 of which (having a length smaller than the depth of the hole 15) is inserted into the hole 15 (FIG. 3). Adhesive is injected in this way until it fills the through-hole 11 in the stripped portion 33, completely coating this stripped portion 33.

For safety, the injection may continue until the adhesive 17 protrudes from each side of the through-hole 11 at 49, as shown in the present case.

The next step (see the fifth successive block diagram) consists in polymerising the adhesive 17 injected into the through-hole 11, firstly closing off the second hole 15 by means of a plug 51 so as to prevent the adhesive 17 from migrating. This operation is carried out using an oven 53, for example at 80° C. for one hour, in which the support piece 5 with the retaining template 37 for the ribbon 13 is placed (see the fifth successive block diagram).

Once the adhesive has polymerised, the retaining template 37 is removed from the support piece 5 and this support piece 5 or the transition 1 obtained is mounted on the optical fiber 7 as shown in the sixth block diagram of FIG. 1, in the rear part 9 of the carcass of the optical connector 7.

Such an optical connector 7 has a transition 1 for the cable 3 forming a watertight barrier for connecting the optical cable 3 to the part 9, which can withstand high pressures, up to 1600 bar, and is therefore designed for a sea environment, especially at great depths.

1. A method of producing a transition for an optical fiber ribbon (13) for a submarine optical connector (7), the method comprising the following steps:
a cable (3) comprising an optical fiber ribbon (13) surrounded by a plastic sheath is provided;
a through-hole (11), for the ribbon to pass through a support piece (5), and a hole (15) transverse to the through-hole (11), capable of allowing an adhesive (17) in the form of a liquid or viscous fluid to flow into the through-hole (11), are provided;
the ribbon (13) is mechanically stripped over a portion of its length corresponding to that of its passage in the support piece (5), this length being slightly smaller than that of the through-hole (11);
the remaining, not mechanically stripped, portion (33) of the ribbon is chemically stripped by means of a solvent (35) for the plastic of the ribbon;
the ribbon (13) is passed into the through-hole (11) of the support piece, placing the stripped portion (33) within the through-hole (11);
an adhesive (17) of the epoxy type, in liquid or even viscous form, is injected into the transverse hole (15) until the adhesive (17) coats at least the stripped portion (33) of the ribbon and at least partly fills the through-hole (11); and
the transverse hole (15) is plugged at its end.

2. The method as claimed in claim 1, wherein the step consisting in mechanically stripping the ribbon (13) over a portion of its length corresponding to that of its passage in the support piece (5) is carried out over a length slightly smaller than that of the through-hole (11), being set back by at least one 1 mm at each end of the through-hole (11).

3. A device for producing a transition for an optical fiber ribbon surrounded by a plastic sheath in a support piece (5) of a submarine optical connector (7), the support piece (5) having a through-hole (11) and a transverse hole (15), the device comprising:
means (19) for mechanically stripping at least one optical fiber ribbon over a defined length, slightly smaller than the length of the through-hole (11) in the support piece (5);
means for chemically stripping the remaining, not mechanically stripped, portion of the ribbon by means of a solvent (35) for the plastic of the ribbon;
means for injecting an adhesive (17) of the epoxy type, in liquid or even viscous form, into the transverse hole (15) until the adhesive coats at least the stripped portion of the ribbon and at least partly fills the through-hole (11); and
means for plugging the transverse hole (15) at its end.

4. The device as claimed in claim 3, wherein the mechanical stripping means (19) comprise:
a support plate (25) for supporting the optical fiber ribbons (13) that are placed parallel to one another on a grooved part (29) of the support plate (25), having a calibrated cross section partly corresponding to that of the optical fiber ribbons (13);
means (23) for fastening the optical fiber ribbons (13); and
means (21) for cutting into the surface of the sheath of the optical fiber ribbons (13), these being intended to strip the ribbons over the defined length.

5. The device as claimed in claim 4, wherein the cutting means comprise a blade (21) designed to be moved along the optical fiber ribbons (13), parallel to the support plate (25) and over a course corresponding to the defined length, away from the means (23) for fastening the ribbons.

6. The device as claimed in claim 4, wherein the fastening means comprise a clamp (23) designed to receive, clamped between it and the support plate, the optical fiber ribbons (13).

7. The device as claimed in claim 6, which comprises, in succession from the upstream end to the downstream end in the direction of advance of the blade (21) over the optical fiber ribbons (13), a clamping assembly (23), for clamping the optical fiber ribbons (13), the blade (21) for stripping the ribbons, which is mounted so as to move relative to the support plate (25) for the ribbons, and a retaining bar (27) for holding the ribbons (13) in place.

8. The device as claimed in claim 5, wherein the blade (21) is designed to have a cutting section capable of cutting the portion of the sheath placed above the silica optical fiber body, as a thin cut strip.

9. A transition (5) for a submarine optical connector (7), having a through-hole (11) in a support piece (5) for an optical fiber ribbon (13) and having a transverse hole (15), to allow an epoxy adhesive to flow through it, and comprising, in said through-hole (11):
at least one portion (33) of the optical fiber ribbon (13), mechanically and chemically stripped over a length smaller than that of the through-hole (11);
adhesive (17) of the epoxy type injected via the transverse hole (15) and coating at least the stripped portion of the ribbon and at least partly filling the through-hole (11) so as to fasten the optical fiber ribbon to the transition; and
means for plugging the transverse hole at its end.

10. A submarine optical connector (7) having a transition (5) as claimed in claim 9.
